(19) United States
(12) Patent Application Publication
(10) Pub. No.: US 2006/0137727 A1
(43) Pub. Date: Jun. 29, 2006

(54) Ultrasonic washing apparatus and ultrasonic washing method

(75) Inventors: Miyuki Shibano, Kanagawa (JP); Shin Okuno, Tokyo (JP); Masato Sakaibara, Aichi (JP)

Correspondence Address: CARRIER BLACKMAN AND ASSOCIATES, 24101 NOVI ROAD, SUITE 100, NOVI, MI, 48375, US

(73) Assignee: Star Cluster Co. Ltd., Kanagawa 229-1123 (JP)

(21) Appl. No.: 10/530,623

(22) PCT Filed: Oct. 7, 2003
(86) PCT No.: PCT/JP03/12833

§ 371 Date: Nov. 21, 2005

(30) Foreign Application Priority Data
Oct. 7, 2002 (JP) 2002-293252

(51) Int. Cl. B08B 3/00; B08B 3/12

(52) U.S. Cl. 134/137; 134/155; 134/184

(57) ABSTRACT

This is an ultrasonic washing technique to enhance, when an object to be washed is subjected to ultrasonic washing, the efficiency of charging and discharging the object to be washed in and out of a washing tank while preventing the apparatus from getting larger in the vertical direction. An inlet and an outlet are provided on the side wall of the washing tank, with closable doors and, after the object to be washed, carried along an upstream shift route is put in through the inlet, it is shut with the door for into a sealed closure, cleaning liquid deaerated in a storage tank is let into a washing tank to subject the object to be washed to ultrasonic washing. After that, the cleaning liquid in the washing tank is returned to the storage tank and the door of the outlet is opened to discharge sideways the object to be washed through the outlet via a downstream shift route

### CROSS-REFERENCE TO RELATED APPLICATIONS

The present application is the U.S. national phase of PCT International Application PCT/JP03/12833, filed Oct. 7, 2003, which in turn, claims priority under 35 USC 119 based on Japanese patent application No. 2002-293252, filed Oct. 7, 2002. The complete disclosure of each of the cited priority documents is hereby incorporated by reference.

### TECHNICAL FIELD

The present invention relates to an ultrasonic washing technique that allows fast and efficient washing for deburring vehicle components or the like, which have been machined.

### BACKGROUND ART

It is already known that complexly shaped automobile components, such as valve bodies, which have been machined, can be very efficiently deburried by the impact of powerful cavitation by ultrasonic washing, resulting in successful removal of extremely small burrs.

In a method generally used by such ultrasonic washing equipment, an object to be washed is put into a washing tank containing cleaning liquid which is expelled internally from the top of the washing tank and, after the liquid is irradiated with an ultrasonic wave to subject of the object to ultrasonic deburring, the object to be washed is retrieved from the washing tank (see, for instance, Japanese Patent Application Laid-Open No. 64-34647 (FIG. 1 through FIG. 3).

However, this method of putting the object to be washed into the washing tank from above and retrieving it by pulling up involves a problem of inability to efficiently wash parts which are successively delivered from the machining line via a conveyance path or the like, such as components of wheeled vehicles, by efficiently shifting them into or retrieving them out of the washing tank.

Moreover, in order to move the object to be washed up and down, the equipment is inevitably increased in vertical size, and a lifting mechanism is also needed for the works, entailing an additional equipment cost.

In view of this problem, an object of the present invention is to improve the efficiency of installing and retrieving the object to be washed in and out of the washing tank when it is to undergo ultrasonic washing, and further to prevent the equipment from becoming increased in vertical size.

### DISCLOSURE OF THE INVENTION

In order to achieve the object stated above, the invention provides ultrasonic washing equipment intended for ultrasonic washing of an object to be washed by putting it into a washing tank containing deaerated cleaning liquid. The washing tank includes an inlet and an outlet for installing and discharging the object to be washed in and out of the washing tank, provided in side walls of the washing tank, and these inlet and outlet are provided with closable doors. The washing tank also includes a shifting mechanism for an object to be washed, in which the shifting mechanism is capable of inserting the object to be washed into the washing tank inlet from a side of the washing tank and discharging the washed object from another side of the washing tank. The shifting mechanism is provided in the vicinities of these inlet and outlet openings. Fluid movement of the cleaning liquid in the washing tank is controlled by a cleaning liquid flow control mechanism, provided to regulate the flow of such cleaning liquid into and out of the washing tank.

In a method according to an aspect of the invenion, the object to be washed is put in from a side of the washing tank through the inlet in the side wall of the washing tank, and after closing the inlet with the door, deaerated cleaning liquid is let into the washing tank to subject the object to be washed to ultrasonic washing. After the washing and after emptying the washing tank of the cleaning liquid and opening the door of the outlet in the side wall of the washing tank, the object to be washed is discharged through the outlet toward a side of the washing tank.

And if this operation is repeated, the works successively delivered from the machining line can be efficiently washed, and moreover the equipment will not increase in vertical size. As used throughout the present specification, the term “works” is intended to mean the same thing as “workpieces”, and refers generically to machined items to be washed and deburred in the apparatus hereof. The works, per se, do not form part of the inventive apparatus, rather, the works are acted upon by the apparatus.

The way of opening and closing the doors of the inlet and the outlet here among other features can be freely selected only if they can pass the object to be washed in an open state, and seal the side of the washing tank in a closed state.

Also, the shifting mechanism for an object to be washed among other features can be selected as desired; for instance a pinion-rack mechanism, a cylinder pressing mechanism or some other system can be used.

Further, the specific configuration or the like of the cleaning liquid charging/discharging mechanism can be selected as desired; for instance an evacuation system, a pumping system or some other system can be used, though it is preferable from the view point of shortening the cycle time to enable the cleaning liquid to be charged or discharged in a short period of time.

Further according to the invention, a plurality of tanks of substantially the same shape as the washing tank are arranged along one line beside the inlet and outlet of the washing tank, the washing tank and these tanks adjoining each other are disposed with their inlet and outlet arranged in mutually opposite positions, a common door is provided between each pair of these inlet and outlet, and by opening or closing these doors the outlet and inlet are enabled to communicate with, or isolated from each other.

By arranging the washing tank the plurality of tanks along one line and washing the object to be washed while it is successively shifted from the upstream tank to the downstream tank, it is made possible to enhance, for instance, the washing effect or the rinsing effect; if in this arrangement a common door is provided between each couple of these inlet and outlet of the adjoining washing tank and other tank, and the outlet and inlet are enabled to communicate with or intercepted from each other by opening or closing these common doors, the object to be washed can be smoothly shifted to another tank, so that works successively delivered via a carriage route or the like can be smoothly washed. In addition, the use of the common doors enable the equipment to be reduced in size.

### BRIEF DESCRIPTION OF THE DRAWINGS

FIG. 1 is a front view showing the basic form of an ultrasonic washing apparatus according to the present invention;

FIG. 2 is a top plan view of the apparatus of FIG. 1;

FIG. 3 is a diagram illustrating one example of a shifting mechanism for an object to be washed;

FIG. 4 shows an example of cleaning liquid circuit of the washing apparatus of FIG. 1;

FIG. 5 is a front view of multi-tank ultrasonic washing apparatus;

FIG. 6 is a plan view of the apparatus of FIG. 5;

FIG. 7 is a detail view of the apparatus of FIG. 5 showing a common door of adjoining tanks;

FIG. 8 shows a sequence of steps, illustrating the way the door of FIGS. 6 and 7 is opened and closed;

FIG. 9 shows an example of cleaning liquid circuit of first and second preparatory tanks; and

FIG. 10 shows an example of a cleaning liquid flow circuit of the washing tank.

### DETAILED DESCRIPTION OF ILLUSTRATIVE EMBODIMENTS, INCLUDING BEST MODES FOR CARRYING OUT THE INVENTION

Embodiments of the present invention will be described below with reference to the accompanying drawings.

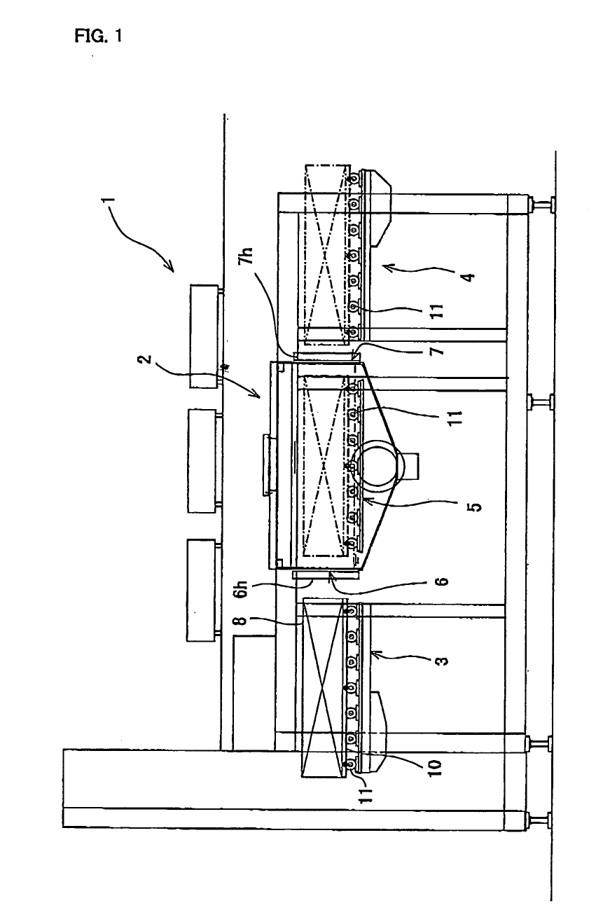

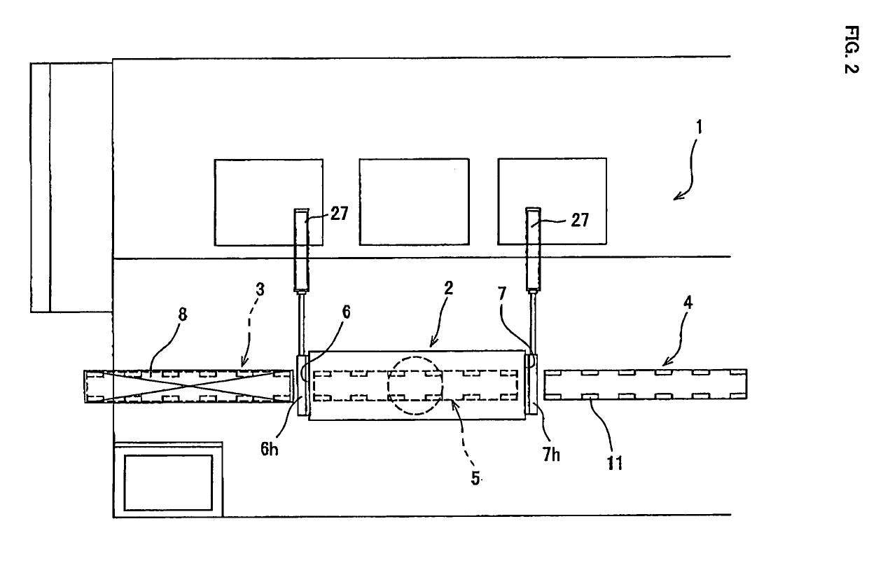

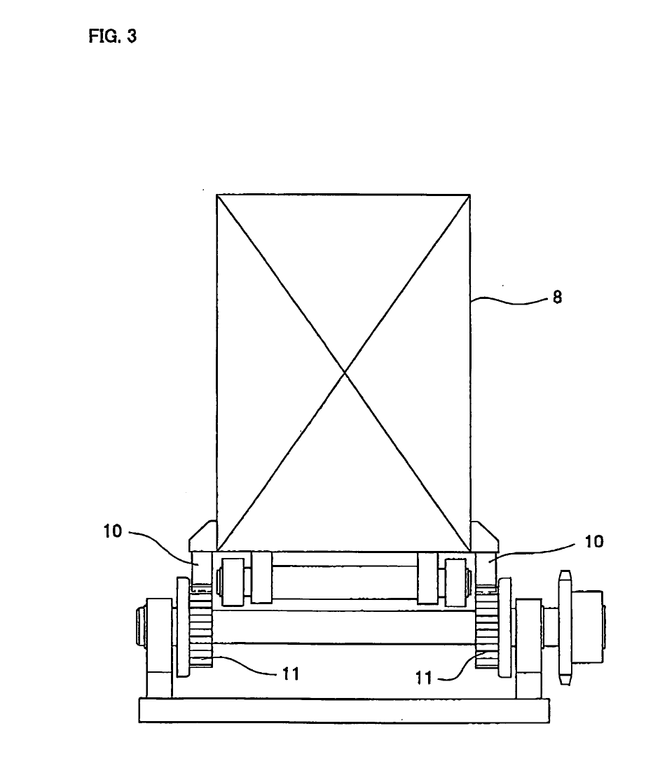

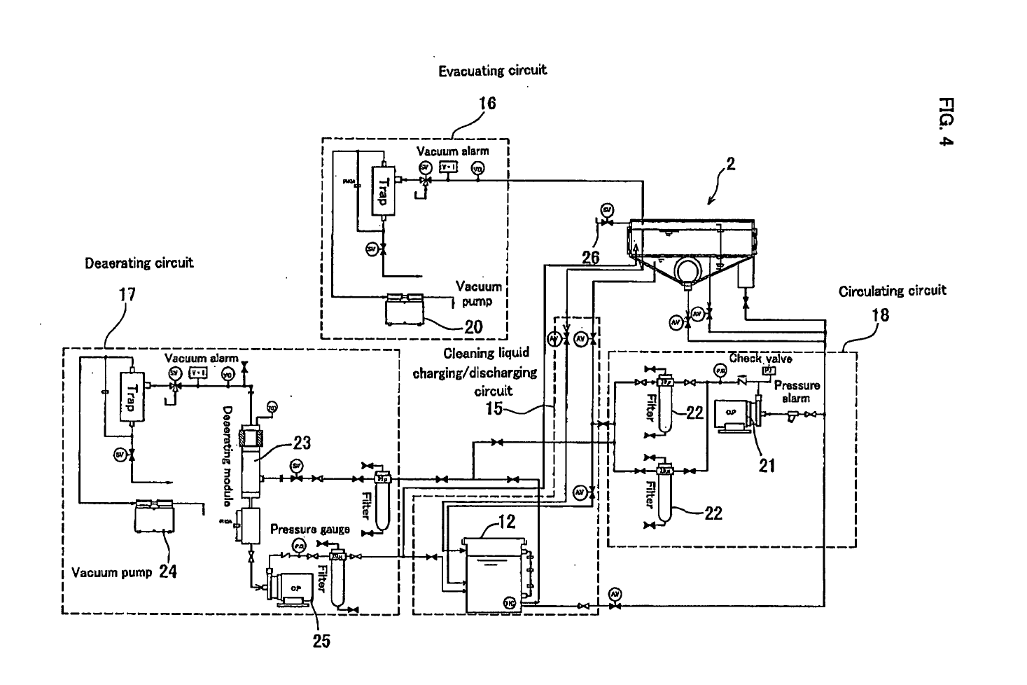

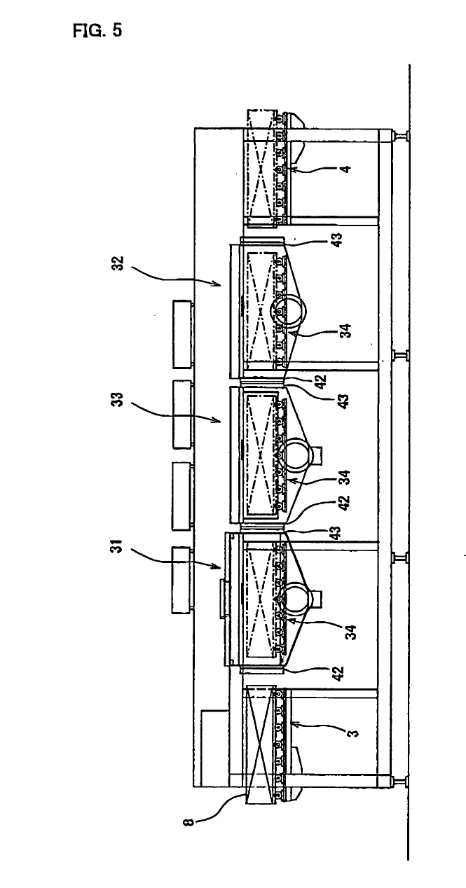

Here, FIG. 1 is a front view showing the basic form of an ultrasonic washing apparatus according to the invention; FIG. 2, a plan of the same; FIG. 3, a diagram illustrating one example of a shifting mechanism for an object to be washed; FIG. 4, a circuit diagram showing an example of cleaning liquid circuit of the washing apparatus; and FIG. 5 through FIG. 10, diagrams illustrating multi-tank ultrasonic washing apparatus.

The ultrasonic washing apparatus according to the depicted embodiment of the invention is intended to make the inputting and retrieval of the works in and out of the washing tank, more efficient, for instance when putting works successively delivered from the machining line or the like to ultrasonic washing, and at the same to prevent the equipment from increasing in vertical size; it is configured as, for instance, as deburring/washing equipment for valve bodies, which are an automobile component item.

Thus, this ultrasonic washing equipment 1, as shown in FIG. 1 and FIG. 2, is provided with a shift route 3 for putting works delivered from a machining line or the like (not shown) into a washing tank 2, for washing and deburring the works. Another shift route 4 is provided for discharging washed works from the washing tank 2. A carriage route 5 is also disposed within the washing tank 2, an inlet 6 closable with a door 6h is disposed in the side wall on the side upstream from the washing tank 2 (the feed shift route 3 side), and an outlet 7 closable with a door 7h is disposed in the side wall on the side downstream from the washing tank 2 (the discharge shift route 4 side).

The shift routes 3 and 4 and the carriage route 5 are enabled to movably support a carrier 8, such as a basket, and a plurality of works can be accommodated within the carrier 8 and carried together as accommodated by the carrier 8. In this embodiment, as shown in FIG. 3, a rack member 10 is fitted to the under surface of the carrier 8. The carrier 8 is moved by engaging this rack member 10 with a plurality each of pinions 111 disposed on the shift routes 3 and 4 and the carriage route 5 side and rotationally driving these pinions 11.

An ultrasonic oscillator for emitting an ultrasonic wave toward the cleaning liquid is provided within the washing tank 2 and, as will be described afterwards, the cleaning liquid in the washing tank 2 can be replenished or discharged.

The washing tank 2 is cleared of the cleaning liquid, the door 6h of the inlet 6 is opened, and the pinions 11 of the upstream shift route 3 and the pinions 11 of the carriage route 5 are rotationally driven to feed the carrier 8 into the washing tank 2. When the feeding is completed, the door 6h of the inlet 6 is closed to let the cleaning liquid into the washing tank 2. Then an ultrasonic wave is emitted to deburry and wash the works.

When the washing is completed, the cleaning liquid is discharged and the door 7h of the outlet 7 is opened, the pinions 11 of the carriage route 5 and the pinions 11 of the downstream shift route 4 are rotationally driven to discharge the carrier 8 out of the washing tank 2.

One example of a cleaning liquid flow circuit of the washing tank 2 will be described with reference to FIG. 4.

The washing tank 2 is provided with a cleaning liquid charging/discharging circuit 15 for charging and discharging the cleaning liquid in and out of the washing tank 2, an evacuating circuit 16 for making the interior of the washing tank 2 vacuum, a deaerating circuit 17 for deaerating the cleaning liquid, and a circulating circuit 18 for circulating the cleaning liquid in the washing tank 2. The cleaning liquid charging/discharging circuit 15 is provided with a storage tank 12 capable of supplying or receiving the cleaning liquid and a water charging/discharging line linking the washing tank 2 and the storage tank 12.

When a valve on the discharging side of the water charging/discharging line of the cleaning liquid charging/discharging circuit 15, the cleaning liquid in the washing tank 2 is discharged by its own weight into the storage tank 12. When the cleaning liquid in the storage tank 12 is to be returned into the washing tank 2, a valve on the charging side of the water charging/discharging line is opened after reducing the pressure within the washing tank 2 by working the vacuum pump 20 of the evacuating circuit 16, and the cleaning liquid is sucked into the washing tank 2.

When the pressure in the washing tank 2 is to be restored to the atmospheric level, the valve of an atmospheric opening line 26 is opened.

The circulating circuit 18 circulates part of the cleaning liquid in the washing tank 2 with a circulating pump 21 and clears it of any dirt with a filter 22. Part of the cleaning liquid is deaerated by the deaerating circuit 17 connected midway on this circuit to be cleared of its gaseous content, and the deaerated cleaning liquid is returned to the washing tank 2.

When the cleaning liquid is in the washing tank 2 and circulating in the circulating circuit 18, the deaerating circuit 17 receives part of the circulating cleaning liquid in circulation and, after deaerating it, returns that pat of the liquid to the washing tank 2. When the cleaning liquid is in the storage tank 12, the circuit receives part of the cleaning liquid in the storage tank 12 and, after deaerating, returns that pat of the liquid to the storage tank 12. Then by removing gases dissolved in the cleaning liquid, the impact of the cavity during the emission of the ultrasonic wave is increased.

For this purpose, this deaerating circuit 17 is provided with a deaerating module 23, a vacuum pump 24, a circulating pump 25 and so forth. The cleaning liquid is sucked into the deaerating module 23 whose internal pressure has been reduced by the vacuum pump 24 and deaerated, and the removed gases are drawn out by the vacuum pump 24 and discharged. The deaerated cleaning liquid is returned by the circulating pump 25 to either the storage tank 12 or the washing tank 2.

The inlet 6 and the outlet 7 are designed in shape and size to permit the carrier 8 to pass, and the door 6h of the inlet 6 and the door 7h of the outlet 7 are enabled to move back and forth by the operation of a cylinder unit 27 as shown in FIG. 2. When the doors 6h and 7h move forward to the positions of the inlet 6 and the outlet 7, respectively, they can close the inlet 6 and the outlet 7 to seal the inside. When they recede, they can open the inlet 6 and the outlet 7.

The actions and other aspects of the ultrasonic washing equipment 1 will now be described.

When the carrier 8 is to be fed into the washing tank 2, the cleaning liquid the washing tank 2 is shifted to the storage tank 12 via the water charging/discharging line of the cleaning liquid charging/discharging circuit 15, to prevent the cleaning liquid from flowing out even if the inlet 6 is opened. After that, the door 6h is opened and the pinions 11 of the shift route 3 and the carriage route 5 are rotationally driven. Then the carrier 8 is shifted into the washing tank 2 through the inlet 6.

Then, the door 6h is shut to close the inlet 6, and after evacuating the interior of the washing tank 2 with the evacuating circuit 16, the charging side valve of the water charging/discharging line of the cleaning liquid charging/discharging circuit 15 is opened to return the cleaning liquid in the storage tank 12 to the washing tank 2.

By then, the cleaning liquid has been deaerated within the storage tank 12 by the deaerating circuit 17, and the washing tank 2 is filled with the deaerated cleaning liquid.

After the internal pressure of the washing tank 2 is returned to the atmospheric level by opening the valve of the atmospheric opening line 26, the liquid level is appropriately adjusted as required with a liquid level sensor or the like. When an ultrasonic wave is emitted by the ultrasonic oscillator into the cleaning liquid, a powerful cavity is generated in the cleaning liquid, and the heavy impact of this cavity removes burrs.

In this way, the cleaning liquid in the washing tank 2 is circulated by the circulating circuit 18, cleared of any dirt by the filter 22 and of any dissolved gases by the deaerating circuit 17, and the heavy impact of the cavity is thereby maintained.

When ultrasonic washing for deburring is completed, the valve on the discharge side of the water charging/discharging line of the cleaning liquid charging/discharging circuit 15 is opened, the cleaning liquid in the washing tank 2 is shifted to the storage tank 12, and the liquid level is made lower than at the lower end of the outlet 7. After the door 7h of the outlet 7 is opened, the pinions 11 of the carriage route 5 and the pinions 111 of the downstream shift route 4 are driven, and the carrier 8 is moved out of the washing tank 2. When the discharging movement of the carrier ends, the door 7h is closed, the cycle returns to its first phase, and the same sequence is repeated.

The works successively delivered from upstream can be efficiently washed in the procedure described above, and no extra trouble is involved in either moving the carriage 8 into or discharging the carraige out of the washing tank 2.

Next will be described an example of a configuration of multi-tank type of ultrasonic washing apparatus according to a second embodiment of the invention will be described with reference to FIG. 5 through FIG. 9.

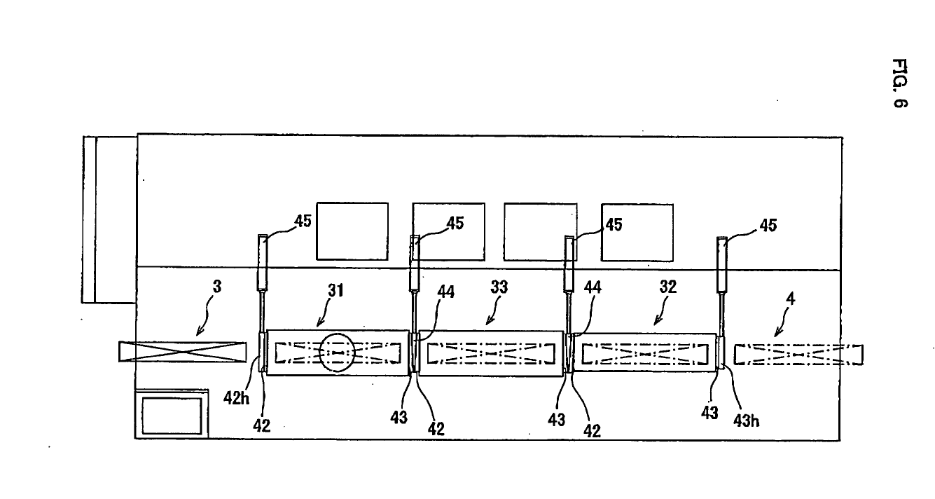

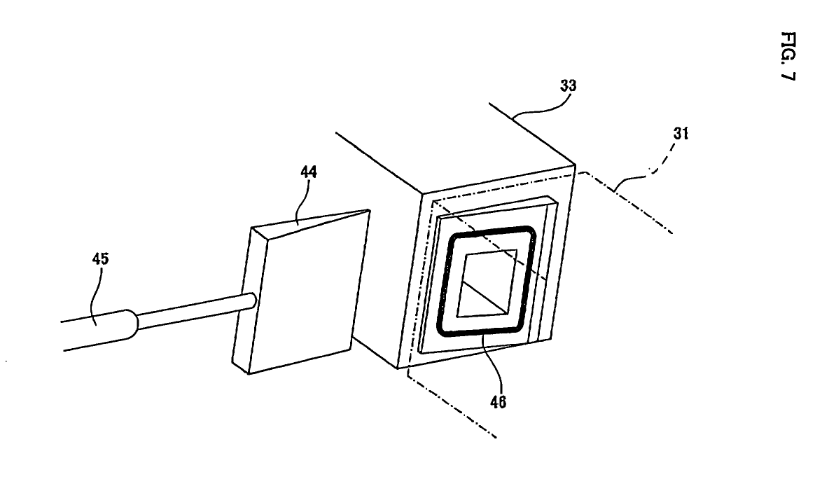

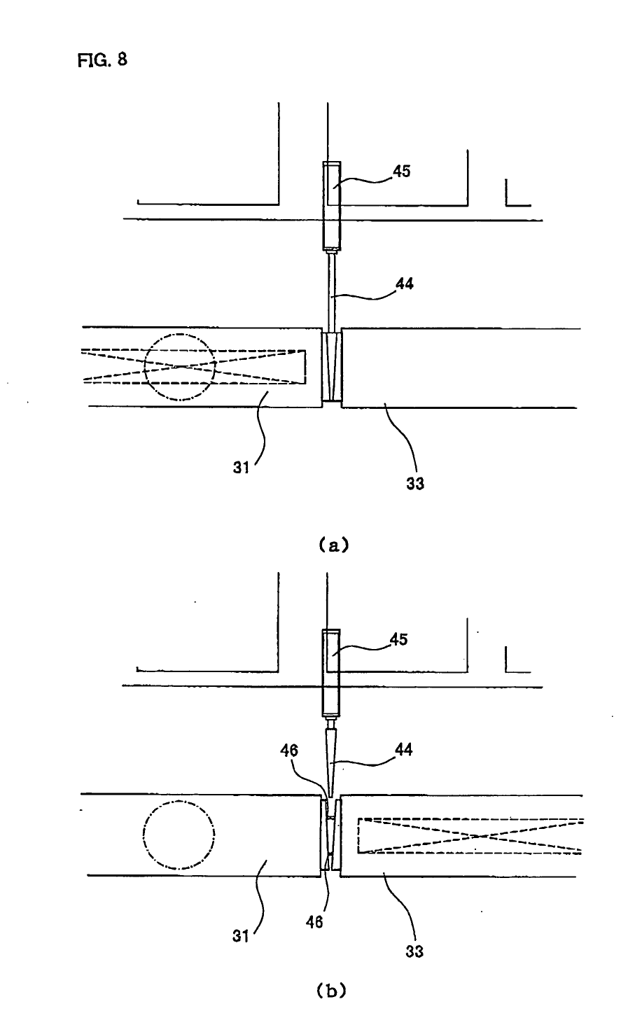

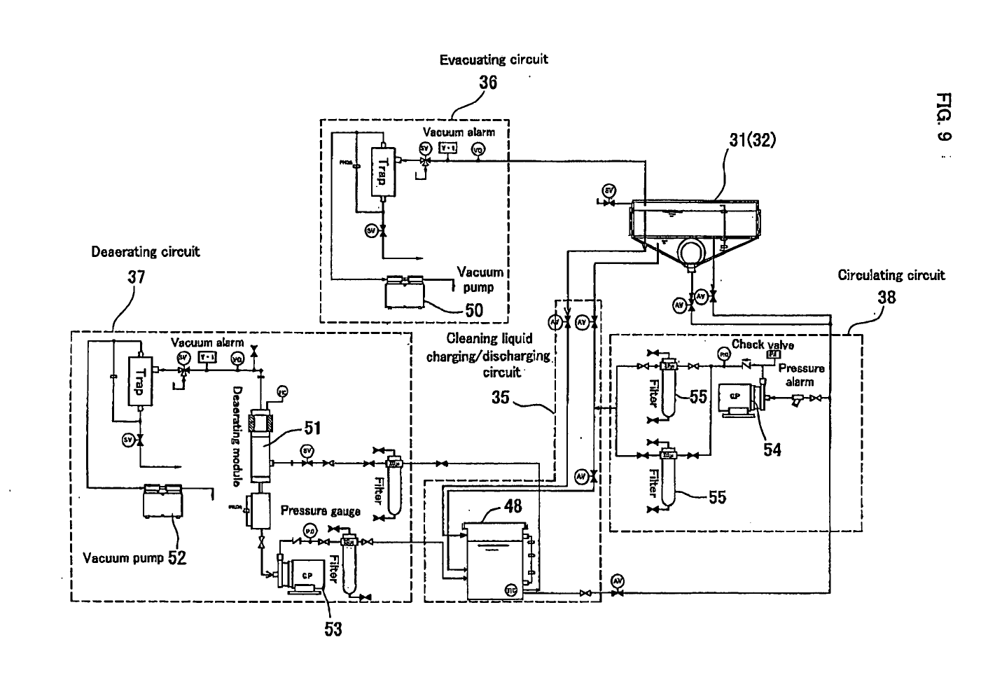

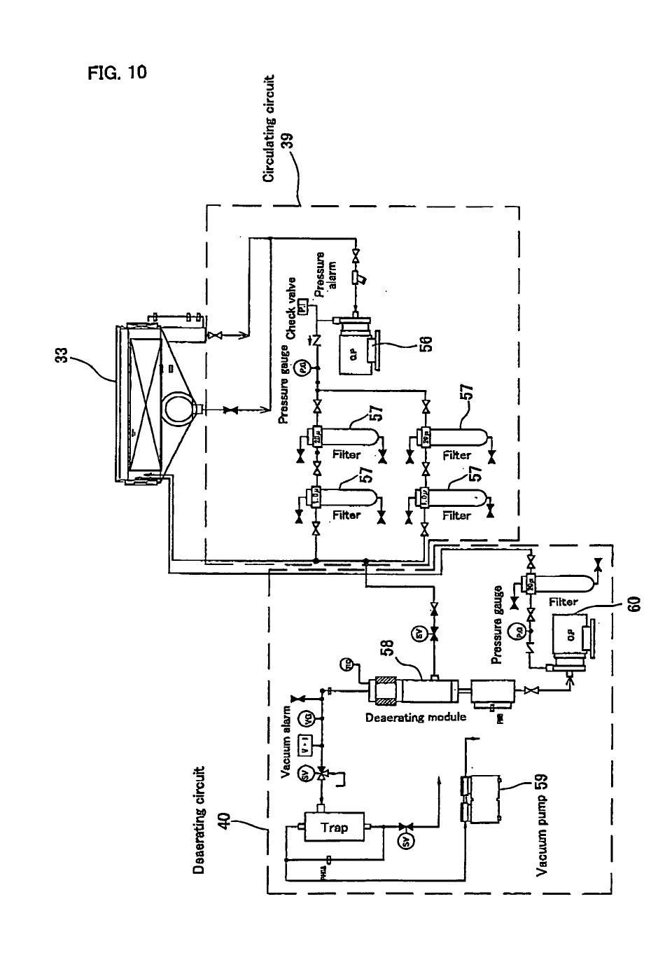

Here, FIG. 5 is a front view of the multi-tank ultrasonic washing apparatus; FIG. 6 is a top plan view of the same; FIG. 7 illustrates a common door of adjoining tanks; FIGS. 8a and 8b are sequential top detail view drawings illustrating the way the door is opened and closed; FIG. 9 shows an example of cleaning liquid circuit of first and second preparatory tanks; and FIG. 10 shows an example of a cleaning liquid flow circuit of the washing tank.

In this example of the multi-tank configuration, a first preparatory tank 31 and a second preparatory tank 32 are disposed on the upstream and downstream sides, respectively, of a carriage route with a washing tank 33 between them, the shift route 3 is arranged on the upstream side of the first preparatory tank 31, and the shift route 4 is arranged on the downstream side of the second preparatory tank 32.

During operation of the multi-tank apparatus, the carrier 8, carried from the upstream shift route 3, is fed into the washing tank 33 via the first preparatory tank 31 and, after going through ultrasonic washing for deburring in the washing tank 2, is discharged outside via the second preparatory tank 32.

For this purpose, inlets 42 and outlets 43 are provided in the side walls of the first preparatory tank 31, the washing tank 33 and the second preparatory tank 32, and carriage routes 34 are disposed within the tanks 31, 32 and 33. An ultrasonic oscillator is arranged only in the washing tank 33 but not in the first preparatory tank 31 or the second preparatory tank 32, and cleaning liquid is charged into or discharge out of only the first preparatory tank 31 and the second preparatory tank 32, but the washing tank 33 holds cleaning liquid all the time.

Cleaning liquid circuits of the first preparatory tank 31 and the second preparatory tank 32 are of substantially the same form. As shown in FIG. 9, there are provided a cleaning liquid charging/discharging circuit 35 for charging or discharging the cleaning liquid into or out of the tanks 31 and 32, an evacuating circuit 36 for making the interior of the tanks 31 and 32 vacuum, a deaerating circuit 37 for deaerating the cleaning liquid, and a circulating circuit 38 for circulating the cleaning liquid in the tanks 31 and 32. These circuits are configured in the substantially same way as their respective counterparts in the foregoing embodiment with some partial exceptions.

For instance, the cleaning liquid charging/discharging circuit 35 is provided with a storage tank 48 and so forth, and the evacuating circuit 36 is provided with a vacuum pump 50 and so forth. The deaerating circuit 37 is provided with a deaerating module 51, a vacuum pump 52, a circulating pump 53 and so forth, and the circulating circuit 38 is provided with a circulating pump 54, a filter 55 and so forth.

The cleaning liquid circuit of the washing tank 33, as shown in FIG. 10, is provided with a circulating circuit 39 for circulating the cleaning liquid and a deaerating circuit 40 for deaerating the cleaning liquid. As the circulating circuit 39 circulates the cleaning liquid in the washing tank 33, the liquid is deaerated by the deaerating circuit 40 while being cleared of foreign matter and the like by filters 57, and the impact of the cavity is thereby increased.

For this purpose, the circulating circuit 39 is provided with a circulating circuit 56, the filters 57 and so forth, and the deaerating circuit 40 is provided with a deaerating module 58, a vacuum pump 59, a circulating pump 60 and so forth.

Incidentally, the outlet 43 of the first preparatory tank 31 and the inlet 42 of the washing tank 33 are disposed in mutually adjacent positions, and so are the outlet 43 of the washing tank 33 and the inlet 42 of the second preparatory tank 32, and a common door 44 is provided between each couple of these tanks as shown in FIG. 6. By opening or closing these doors 44, the outlet 43 and the inlet 42 are respectively caused to communicate with or isolated from each other.

Thus, as is evident from FIG. 6 and FIG. 7, each common door 44 is wedge-shaped and can be moved back and forth by the operation of a cylinder unit 45, while the inlet 42 or the outlet 43 is surrounded by a packing material 46, which can be inflated or submerged by elastic force.

And as shown in FIG. 8(a), when a common door 44 advances toward the fronts of an inlet 42 and an outlet 43, the communication is intercepted to seal the inside; as shown in FIG. 8(b), when the door 44 recedes from the fronts of the inlet 42 and the outlet 43, the packing materials 46 on both sides inflate to establish communication between the inlet 42 and the outlet 43 and to prevent the liquid from leaking out.

The washing method in the ultrasonic washing equipment described above will now be described.

The first preparatory tank 31 is emptied by shifting the cleaning liquid in it to the storage tank 48, and the cleaning liquid is cleared of its gaseous contents by the deaerating circuit 37. When the carrier 8 is conveyed from the upstream shift route 3, the carrier 8 is let in to the first preparatory tank 31 by opening the door 42h of the inlet 42 of the first preparatory tank 31.

When the carrier 8 is let into the first preparatory tank 31, the door 42h is closed to seal the inside, and after the pressure in the tank is reduced by the evacuating circuit 36, the valve on the charging side of the water charging/discharging line of the cleaning liquid charging/discharging circuit 35 is opened to let the cleaning liquid into the tank 31. And, after adjusting as required the liquid level to equalize it with that of the washing tank 33, the circulating circuit 38 is actuated to circulate the cleaning liquid, and the cleaning liquid is deaerated while being cleared of foreign matter by the filters.

When the work is cleared of sticking foreign matter and the cleaning liquid has been deaerated to a desired level, the operation of the circulating circuit 38 is stopped, and the work is shifted to the washing tank 33. Then, if the common door 44 between the first preparatory tank 31 and the washing tank 33 is opened, communication will be established between the tanks 31 and 33, and the carrier 8 will be fed into the washing tank 33 through the carriage routes 34 in the tanks 31 and 33.

And when the carrier 33 is fed into the washing tank 33, the common doors 44 is closed to seal the inside, and ultrasonic washing is started.

When the ultrasonic washing in the washing tank 33 is completed, the carrier 8 is shifted into the second preparatory tank 32 in a similar procedure. When the common door 44 between the washing tank 33 and the second preparatory tank 32 is to be opened in this process, the second preparatory tank 32 has been filled with cleaning liquid to a prescribed level in advance; when the carrier is fed into the second preparatory tank 32, the circulating circuit 38 of the second preparatory tank 32 is actuated to deaerated the cleaning liquid while clearing it of foreign matter. After a rinsing effect has been achieved, the cleaning liquid charging/discharging circuit 35 shifts the cleaning liquid to the storage tank 48, and after the tank 32 is cleared of cleaning liquid inside, the door 43h of the outlet 43 is opened to discharge the carrier 8.

And by repeating this operation in the tanks 31, 33 and 32, the works successively delivered to them can be efficiently washed in a cyclic process.

To add, the present invention is not limited to the embodiments described above. What has substantially the same configuration and exerts substantially the same effect as what is described in the claims of the invention belongs to the technical scope of the invention.

For instance, the number of tanks can be selected as desired, and the configuration of the cleaning liquid circuit in each tank is only illustrative. Also, the shifting mechanism for the carrier 8 may be a cylinder or the like. Further, the type of the works, the washing method, and other features can be selected as desired.

### INDUSTRIAL APPLICABILITY

Since the ultrasonic washing apparatus according to the invention has an inlet and an outlet for admitting and discharging the object to be washed into and out of the washing tank are provided in side walls of the washing tank of the ultrasonic washing apparatus. The objects to be washed are charged and discharged sideways through these inlet and outlet, there is no need to move the object to be washed up and down, the works successively delivered from the machining line, and moreover the equipment is not increased in vertical size.

Further, if a plurality of tanks in substantially the same shape as the washing tank are arranged along one line beside the inlet and outlet of the washing tank, their inlet and outlet are positioned opposite each other and a common door is disposed between the inlet and outlet, it is made possible to enhance the washing effect by the use of the plurality of tanks and to achieve a rinsing effect, moreover enabling the equipment to be reduced in size.

1. Ultrasonic washing apparatus for ultrasonic washing of an object to be washed by putting it into a washing tank containing deaerated cleaning liquid, said apparatus comprising:
a washing tank having side walls with an inlet opening and an outlet opening formed therein for charging and discharging the object to be washed in and out of the washing tank, wherein said inlet and outlet are provided with closable doors,
a shifting mechanism for shifting the position of an object to be washed, wherein said shifting mechanism is capable of charging the object to be washed into the washing tank from a side of the washing tank and discharging the object to be washed in the washing tank toward a side of the washing tank and is provided in the vicinities of said inlet and outlet,
a storage tank for temporarily storing cleaning liquid, and
a cleaning liquid flow control mechanism for controlling flow of cleaning liquid in said apparatus, wherein said flow control mechanism is operable to set a resting level of the cleaning liquid below the heights of the inlet and the outlet by shifting the cleaning liquid in the washing tank to a storage tank at the time of putting the object to be washed into the washing tank through the inlet and at the time of discharging the object in the washing tank through the outlet, and to set a working level of the cleaning liquid above the heights of the inlet and the outlet by shifting the cleaning liquid from the storage tank to the washing tank at the time of washing the object.

2. The ultrasonic washing apparatus according to claim 1, further comprising a plurality of auxiliary tanks of substantially the same shape and configuration as the washing tank, wherein the auxiliary tanks are arranged along one line beside the inlet and outlet of said washing tank, wherein each of the washing tank and these auxiliary tanks are disposed with their respective inlet and outlet openings arranged in mutually opposite positions, a common door is provided between each adjacent pair of these inlet and outlet openings, and wherein said apparatus is operable in a manner such that by opening or closing these doors said outlet and inlet openings are enabled to communicate with or are isolated from each other.

3. An ultrasonic washing method, comprising the steps of:
putting an object to be washed from a side of a washing tank through an inlet formed in a first side wall of the washing tank, with the level of the cleaning liquid in the washing tank being kept below the height of the inlet in the side wall of the washing tank;
closing the inlet with a door,
letting deaerated cleaning liquid into the washing tank after the inlet door has been closed,
ultrasonically washing the object within the washing tank,
removing some of the cleaning liquid from the washing tank to bring the level thereof to a level below the height of an outlet formed in another side wall of the washing tank,
opening a door covering the outlet, and
discharging the washed object through the outlet.

4. The apparatus of claim 1, further comprising expandable packing material operatively associated with said inlet and with said outlet.

5. The apparatus of claim 2, further comprising expandable packing material operatively associated with said inlet and with said outlet of each of said washing and auxiliary tanks.

6. An ultrasonic washing apparatus, comprising:
a washing tank having side walls and a floor cooperating to define a washing chamber, said washing tank having an inlet opening formed in a first of said side walls and an outlet opening formed in a second of said side walls;
an inlet door operatively associated with a shifting mechanism for shifting the position of an object to be washed, wherein said shifting mechanism is capable of charging the object to be washed into the washing tank from a side of the washing tank and discharging the object to be washed in the washing tank toward a side of the washing tank and is provided in the vicinities of said inlet and outlet,
a storage tank for temporarily storing cleaning liquid,
an ultrasonic signal generator, and
a cleaning liquid flow control mechanism for controlling flow of cleaning liquid in said apparatus, wherein said flow control mechanism is operable to set a resting level of the cleaning liquid by shifting cleaning liquid from the washing tank to a storage tank at the time of putting the object to be washed into the washing tank through the inlet and at the time of discharging the object in the washing tank through the outlet, and to set a working level of the cleaning liquid by shifting cleaning liquid from the storage tank to the washing tank in preparation for washing the object.

7. The ultrasonic washing apparatus according to claim 6, further comprising:
a plurality of auxiliary tanks of substantially similar shape and size as the washing tank, each of the auxiliary tanks having an inlet and an outlet formed in opposed side walls thereof, wherein the auxiliary tanks are arranged substantially in line with the inlet and outlet of said washing tank, wherein each of the washing tank and these auxiliary tanks are disposed with their respective inlet and outlet arranged in mutually opposite positions, and
a common door provided between each adjacent pair of these inlet and outlet openings, wherein said apparatus is operable in a manner such that by opening these common doors, said adjacent outlet and inlet openings are enabled to communicate with each other, and by closing these common doors, said adjacent inlet and outlet openings are isolated from each other.

8. The apparatus of claim 6, further comprising expandable and compressible packing material operatively associated with said inlet and with said outlet.

9. The apparatus of claim 7, further comprising expandable and compressible packing material operatively associated with said inlet and with said outlet of each of said washing and auxiliary tanks.
